(19) United States
(12) Patent Application Publication
(10) Pub. No.: US 2014/0093037 A1
(43) Pub. Date: Apr. 3, 2014

(54) Measuring a Flow-Rate and Composition of a Multi-Phase Fluid Mixture

(71) Applicant: Stepan Polikhov, Ramenskoye (RU)

(72) Inventor: Stepan Polikhov, Ramenskoye (RU)

(21) Appl. No.: 14/100,002

(22) Filed: Dec. 8, 2013

Related U.S. Application Data
(63) Continuation-in-part of application No. PCT/RU2011/000404, filed on Jun. 8, 2011.

(51) Int. Cl. G01N 23/04

(52) U.S. Cl. CPC G01N 23/04
USPC 378/53; 378/62

(57) ABSTRACT

An apparatus for measurement of a flow-rate and/or a composition of a multi-phase fluid mixture is provided. The apparatus includes a radiation device that generates a pulsed beam of photons to irradiate the fluid mixture spatially along a section of flow of the mixture. A controlling device is configured to apply a predetermined, time-dependent voltage to the radiation device during a single pulse of photons. A detection device is spatially configured for receiving photons emanating from the section of flow of the mixture at different points in time during the pulse of photons to form images of a spatial distribution of the received photons for each of points in time. An analysis device is configured for determining the flow rate of one or more phases of the mixture and/or the composition of the mixture based on a temporal sequence of the images of the spatial distribution of the received photons.

This application is a continuation-in-part of PCT Application No. PCT/RU2011/000404, filed on Jun. 8, 2011, and designating the United States, the entire disclosure of which is hereby incorporated by reference.

### BACKGROUND

The present embodiments relate to measurement of a flow-rate and/or a composition of a multi-phase fluid mixture. One or more of the present embodiments may find application, for example, in the oil and gas industry, where a mixture of liquid hydrocarbons gaseous hydrocarbons is of concern.

The problem of measuring the flow-rates of multi-phase fluids in a pipe without the need to interrupt fluid flow or separate the phases during the measurement process is of importance in the chemical and petroleum industry. Because almost all wells produce a mixture of oil, water, and gas, flow measurements of the individual components of the fluid mixture are to be provided in the efficient production of a reservoir.

The above problem has been addressed by multi-phase flow-meter devices that are now commonly used in the oil and gas industry and other chemical industries. Such devices measure the flow velocity of various components of a multi-phase fluid mixture by measurement of Gamma ray or X-ray attenuation through the mixture at two different energy levels (e.g., a “high” energy level and a “low” energy level). The measurements are based on the fact that the absorption coefficient of the Gamma ray/X-ray radiation is dependent on the material and the photon energy. Accordingly, the “high” energy level is determined such that the photon absorption coefficient at this energy level of photons is substantially the same for oil and water. The “low” energy level is determined such that the photon absorption coefficient at this energy level of photons is significantly higher for water than for oil. The Gamma rays/X-rays pass through the mixture in a test section of the pipe and irradiate detectors that are sensitive to photons and these two energy levels. Analysis of the signals recorded by the detectors allows evaluation of water, oil and gas flow-rates passing through the test section.

From WO 2011/005133 A1, an apparatus for measuring the flow velocity of a multi-phase fluid mixture is known. The proposed apparatus includes a radiation device, a detection device and an analysis device. The radiation device generates a beam of photons to irradiate that mixture spatially over a section of flow of the mixture. The detection device is spatially configured to receive photons emanating from the section of flow of the mixture at different intervals of time, and provides an image of a spatial distribution of the received photons for each interval of time. The analysis device determines flow velocity of one or more phases of the mixture based on a temporal sequence of the images of the spatial distribution of the received photons.

WO 2011/005133 A1 suggests to use X-ray photons so that no radioactive materials are required. The radiation device is adapted for alternately generating first and second pulses of photons. The photons in the first pulse have a first energy level, and the photons in the second pulse have a second energy level. To provide low overall power consumption while providing large instantaneous power during the pulses, a pulsed power supply with two X-ray tubes is used with a stable endpoint voltage. The first X-ray tube generates a beam of X-ray photons at the first energy level, while the second X-ray tube generates a second beam of X-ray photons at the second energy level.

EP 1760793 A2 discloses an energy selective X-ray radiation sensor that allows low-energy X-ray photons or high energy X-ray photons to be selected in a particular read-out. A standard AC X-ray may be used to emit x-ray energy cyclically in a similar way to a full wave rectified waveform. During low energy X-ray periods and during high energy X-ray periods, photo-generated charge is collected in a photodiode.

US 2010/098217 A1 discloses a system that includes a rotatable gantry for receiving an object to be scanned. The system includes an x-ray source for projecting x-rays of two different energy levels towards the object and also a power supply that energizes the X-ray source to two different voltage levels at a predetermined rate for generating X-rays at two different energy levels. The power supply in the system includes a fixed voltage source to input a voltage to a switching module with a number of identical switching stages. Each stage in the switching module includes a first switch that charges a capacitor in a conducting state and outputs a first voltage, a second switch that connects the fixed voltage source and the capacitor in series to output a second voltage in a conducting state, and a diode that blocks a reverse current from the capacitor to the power supply.

JP2009297442A discloses an X-ray CT apparatus capable of acquiring a dual-energy. The X-ray CT apparatus includes an X-ray irradiation part for irradiating a subject while switching between X-rays with first energy and X-rays with second energy. The X-ray CT apparatus also includes an X-ray projection data collecting part for collecting projection data of the X-rays applied to the subject. The X-ray CT apparatus includes an image reconstructing part. The image reconstructing part includes a first image reconstruction part and a second image reconstructions part. The first image reconstruction part reconstructs a first image using the X-ray projection data based on the X-rays having the first and second energy excluding the X-ray projection data collected in a transition section. The second image reconstruction part reconstructs a second image using the X-ray projection data based on the X-rays having the first and second energy including the X-ray projection data collected in the transition section.

### SUMMARY AND DESCRIPTION

The scope of the present invention is defined solely by the appended claims and is not affected to any degree by the statements within this summary.

The present embodiments may obviate one or more of the drawbacks or limitations in the related art. For example, an improved apparatus and method for measurements of a flow-rate and/or a composition of a multi-phase fluid mixture are provided.

The flow velocity of one or more phases of the mixture is directly measured based on a temporal sequence of the spatial distribution of photons emanating from the mixture that are received by the detection device. To simplify the apparatus and the method for measurement, the radiation means adapted for generating a pulsed beam of photons to irradiate the fluid mixture spatially along a section of flow of the mixture is controlled by a controlling device. The controlling device is adapted for applying a voltage to the radiation device. A detection device is spatially configured for reviving photons emanating from the section of flow of the mixture to form images of a spatial distribution of the received photons for each of the points in time. An analysis device is adapted for determining the flow-rate of one or more phases of the mixture and/or the composition of the mixture based on a temporal sequence of the images of the spatial distribution of the received photons. The voltage applied to the radiation device is a predetermined, time-dependent voltage having any course between a starting voltage and an end voltage during a single pulse of photons. The photons emanated from the section of flow of the mixture are received at different points in time during the single pulse of photons.

Since the voltage and, as a result, the spectra of the emitted photons (e.g., of a X-ray) is changing during the single pulse, images may be acquired for a set of X-ray energies. As a result, the fact that different materials have different X-ray intensity versus distance attenuation dependence for different X-ray spectra may be taken advantage of. This embodiment advantageously allows a single X-ray tube to be used to obtain multiple images for different X-ray spectra at the exit of the X-ray source.

In one embodiment, the radiation device is adapted to apply a predetermined, time-dependent current to the radiation device to have the number of photons acquired by the detection device in a predetermined range. While controlling the voltage applied to the radiation device during a single pulse of photons influences the energy of the photons, controlling the current during a single pulse of photons influences the amount of photons acquired by the detection device. Controlling the current may therefore be used to consider the intensity of received photons emanating from the section of flow of the mixture.

In a further embodiment, the detection device is adapted to form at least two images of a spatial distribution of received photons at the different point in time. This embodiment provides that images of photons having different energy levels are made.

In a further embodiment, the detection device includes a two-dimensional array of detector elements. This embodiment advantageously allows measurement of a spatial density distribution of the mixture transverse to the direction of flow of the mixture.

In another embodiment, the analysis device is adapted to determine the flow velocity of one or more phases of a mixture based on a cross-correlation of the temporal sequence of images of the spatial distributions of received photons. In one alternative of this embodiment, the detection device is adapted to control the timing between the acquisition of the images of different pulses such that the images are made for same energy bands. In another alternative, the detection device is adapted to control the timing between the acquisition of the images of different pulses such that the images are made for different energy bands. As a result, the volumetric flow-rate may be measured for each phase directly without introducing a contraction, such as a Venturi restriction, into the direction of flow of the mixture.

In a further embodiment, the radiation device is adapted to adjust the time between succeeding pulses of photons.

One or more of the present embodiments are based on the idea of using a pulsing radiation device (e.g., a X-ray source). During a single pulse of photons, the radiation device will be controlled such that the voltage, and optionally the current, is changed. Within the single pulse of photons, at least two images of a spatial distribution of the received photons are formed at different points in time for obtaining images for different energy spectra at the exit of the radiation device. As a result, the known dual energy principal may be replaced with a multiple energy one. Since there may be only one photon source provided, the spatial resolution for the detecting device may be significantly improved.

By conducting a cross correlation analysis of the two-dimensional images that are recorded by the detection device for several energy spectra of the radiation device, velocity measurements of one or more phases of the fixed mixture may be made. The analysis allows a direct volumetric velocity measurement.

### BRIEF DESCRIPTION OF THE DRAWINGS

FIG. 1 is a schematic diagram of one embodiment of an apparatus for measuring multi-phase fluid flow;

FIG. 2 is a top view of one embodiment of the apparatus of FIG. 1 for measuring multi-phase fluid flow having a two-dimensionally arranged detector,

FIG. 3 is a schematic diagram of an exemplary time-dependent voltage during a single pulse of photons;

FIG. 4 is a schematic diagram of an exemplary time-dependent current during a single pulse of photons; and

FIG. 5 is a schematic diagram illustrating an exemplary duty cycle of a radiation device of the apparatus.

### DETAILED DESCRIPTION

Embodiments described below provide a direct measurement of volumetric flow velocity (e.g., a flow-rate) of individual phases of a multi-phased mixture and a composition of the multi-phased mixture by taking into account spatial fluid flow over a section. The multi-phased mixture may be a mixture of gas (e.g., gaseous hydrocarbons), water, and/or oil (e.g., liquid hydrocarbons). An individual phase may be one of the components. By irradiating the multi-phased mixture over the entire cross-section of the mixture flow, the spatial density distribution of the phases transverse to the flow direction, which includes the quality and accuracy of the volumetric flow measurement, may be determined.

FIG. 1 shows one embodiment of an apparatus 1 for measurement of multi-phase fluid flow. The apparatus 1 may also be referred to as a multi-phase flow-meter. The apparatus 1 includes a radiation device 2, a detection device 3, an analysis device 4 and a controlling device 6. The illustrated apparatus 1 also includes a measurement tube 13 that may, for example, be interposed between upstream and downstream pipes 20 and 21, respectively, through which a multi-phase fluid mixture flows with a flow-rate to be measured. The multi-phase fluid mixture may, for example, be a mixture that occurs in upstream oil and gas business. The measurement tube 13 forms a conduit for a section 19 of the mixture flow. The section 19 may refer to a volume of the mixture within the measurement tube 13 or a portion thereof. The section 19 is also referred to herein as “test section”.

The radiation device 2 generates a beam of photons to irradiate mixture spatially along the test section 19. The photon beam is attenuated upon passing through the mixture. The detection device 3 is configured to spatially receive photons emanating from the test section 19 of flow of the mixture at different points in time during a single pulse of photons. The detection device 3 thus forms images of the spatial distribution of the received photons for each of the points in time. The analysis device 4 determines the flow-rate and/or composition of one or more phases of the mixture based on a temporal sequence of the images of the spatial distributions of the photons received by the detection device.

The radiation device 2 is controlled by the controlling device 6. The controlling device 6 controls the shape of the voltage, and optionally, of the current that is applied to the radiation device 2 during a single pulse of photons. At least the voltage applied to the radiation device 2 is varied over time between a minimum voltage and a maximum voltage. By varying the voltage over a time within a single pulse of photons, spectra of the emitted photons is changing during the single pulse. Therefore, images may be acquired for a set of photon energies by forming images of the spatial distribution of the received photons for the mentioned points in time during the single pulse of photons. Additionally, varying the current between a minimum and a maximum current over the time influences the amount of photons that may be acquired by the detection device 3. Advantageously, the number of photons may be controlled in a predetermined range of the detection device 3.

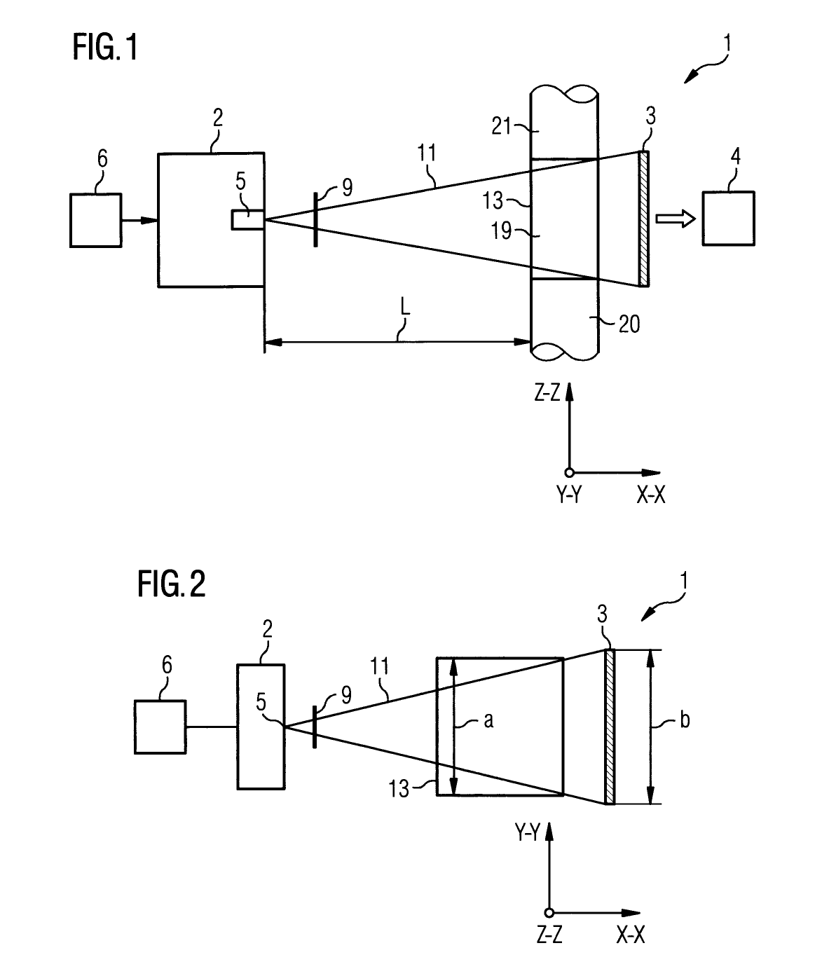

Individual components of the apparatus 1 are discussed in detail below referring to FIGS. 1 and 2. FIG. 2 is a top view of one embodiment of a radiation device 2, the detection device 3, the controlling device 6 and the measurement tube 13. FIGS. 1 and 2 are illustrated with respect to mutually perpendicular axes X-X, Y-Y and Z-Z. The axis Z-Z extends along a flow direction of the mixture, the axis X-X extends along a lateral direction generally along the direction of travel of the photon beam, and the axis Y-Y extends along a transverse direction across the section 19 of mixture flow.

In the illustrated embodiment, the measurements are done using X-ray photons, which is advantageous since X-ray generation does not require radioactive material that requires additional safety measures and may also cause significant problems with import/export operations. Due to the possibility of generating photons having different levels of energy, the radiation device 2 includes only one X-ray tube 5. The X-ray tube 5 generates a beam 11 of X-ray photons at an energy level that is dependent from the voltage applied to the X-ray tube 5 during a single pulse of photons. The voltage is chosen such that at least a “high” energy level and a “low” energy level are provided. The “high” energy level may be in a range of 65-90 keV, while the “low” energy level may fall, for example, in the range of 15-35 keV. The controlling voltage is adapted in a manner that the denoted energies are reached.

For example, for flow measurement in an efficient flow regime including three phases including water, oil and gas, the “high” energy level is chosen such that the photon absorption coefficients for the liquid phases (e.g., water and oil) are substantially constant for photons at this energy level, while the “low” energy level is chosen such that for photons at this energy level, the photon absorption coefficients for water and oil are significantly different. The photon absorption coefficient of the gaseous phase under the given circumstances is much lower in comparison to the photon absorption coefficient of water and oil.

As already mentioned, the X-ray tube 5 is operated in a pulsed mode. Using pulsed power supply advantageously leads to lesser overall power consumption and provides higher instantaneous power during the pulses. The duration of the pulses may be based, for example, on the expected velocity range of the mixture flow to provide that the fluid (mixture) does not cover significant distance during the irradiation and the forming of the at least two images during one pulse.

In the illustrated embodiment, the photon beam 11 passes through a beam shaping aperture 9 that provides a desired shape for cross-section to the beam. The photon beam 11 passing through the aperture 9 irradiates the test section 19 of the mixture flow spatially. In the illustrated embodiment, the spatial irradiation of the test section 19 is along the Z-Y plain (e.g., spatially along the flow direction and transverse to the flow direction), as illustrated in FIG. 2. This, in conjunction with two-dimensional detection device 3 enables measurement of spatial density distribution of the phases of the mixture transverse to the direction of mixture, which is useful for accurately measuring flow velocity in case of non-uniform flow (e.g., fluid flow having non-uniform composition of phases across the cross-section of the flow).

In one embodiment, the radiation device 2 is located at a distance L from the test section 19 and not attached to the measurement tube 13. This allows the divergent photon beam 11 to sufficiently irradiate the test section 19 of fluid flow. The distance L may be greater than 0.3 m and or greater than about 0.5 m.

The measurement tube 13 includes windows made of material that may be transparent to the irradiation by the photon beam 11. In one embodiment, Beryllium may be used for such a window. Although the measurement tube 13 may have any cross-section, a rectangular (e.g. including square) cross-section of the measuring tube 13 may be provided in case of non-uniform mixture flow, providing ease of processing of the spatial images acquired by the detection device 3 for measurement of spatial density distribution of the various phases across the section 19 of the mixture flow.

The photon beam 11 is attenuated upon passing through the mixture. The detection device 3 is accordingly spatially configured to receive the photons emanating from the mixture. In case of flow measurement concerning mixtures having uniform composition of phases across the section of flow, the detection means 3 may be spatially configured to receive photons along one dimension. For flow measurement concerning mixtures having non-uniform composition of phases across the section of flow, the detection device 3 may be spatially configured two-dimensionally. The detection device 3 includes a two-dimensional array of detector elements or a set of detector elements arranged over a two-dimensional area. The array of detector elements is arranged parallel to the Z-Y plain. The dimension b of the detector array may be equal to or greater than the dimension a of the measurement tube 13. The detector elements may include, for example, scintillators, which may include inorganic or organic scintillator crystals, organic liquid scintillators or even plastic scintillators. The detector elements may be sensitive to photons between the above mentioned “high” and “low” energy level. The detector array may include associated photon multipliers for generating signals corresponding to the irradiation of the detector elements.

The detection device 3 receives photons for different points in time of each single pulse of photons and forms a set of images for each pulse of the spatial distribution of photons received during the points in time. Each image corresponds to a different energy level due to the varying time-dependent voltage during a pulse of photons. The detector elements should be able of capturing at least two images within a single pulse of photons.

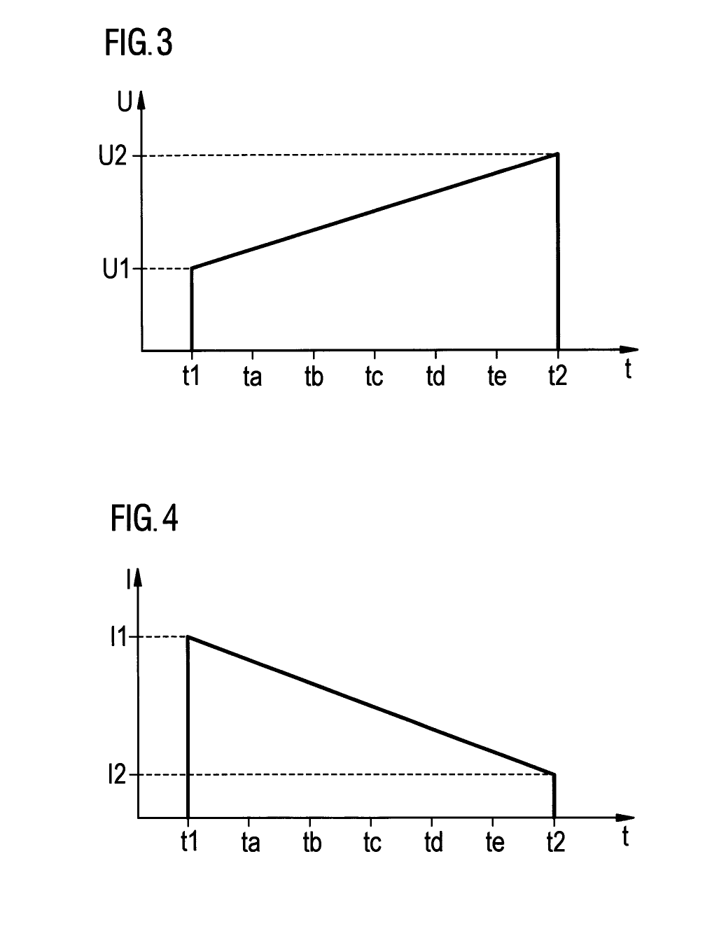

An exemplary embodiment of varying voltage U and current I during a single pulse of photons is given in FIGS. 3 and 4. The pulse of photons starts at t1 and ends at t2. By way of example, the voltage is linearly increased from U1 to a voltage U2. In contrast and again by way of example, the current is decreased starting from current I1 to current I2. The variation of the voltage and current, respectively, does not have to be done linearly. Also, the voltage does not have to be increased during the pulse of photons. Voltage may be decreased from a starting voltage to an end voltage or have any course between U1 and U2. The same applies to the time-dependent current.

Varying the current I during the pulse of photons influences the number of photons acquired by the detection device 3. Signal processing may thus be facilitated by controlling the number of photons in an optimal range for the detection device 3.

In an alternative embodiment, the pulses of photons may be controlled in a way to apply the pulses to the X-ray tube 5 in a manner to acquire X-ray images with the detection device 3 for the same voltage at the X-ray tube with precisely defined time between the X-ray images. This allows performing velocity measurements via cross-correlation analysis for different X-ray energy spectra. Therefore, the velocity for each phase passing through the test section 19 may be defined.

It is advantageous if the timing between the acquisitions of images for the same energy bands is arranged in a manner that the cross-correlation analysis provides the best accuracy. Appropriate timing between paths of “high” energy and “low” energy images allows performing the cross-correlation analysis. Therefore, the volumetric flow rate may be measured for each phase directly.

The detection device 3 is configured to feed a temporal sequence of images to the analysis device 4 (FIG. 1) for determination of a flow-rate and/or a composition of one or more phases of the mixture. Each image represents a spatial distribution of photons received at a specific print in time. In FIGS. 3 and 4, different points in time ta, tb, tc, td, to are set out indicating the forming of images of the spatial distribution of the received photons within the pulse of photons. In the embodiment shown, five images are recorded. However, the amount of images and the time between the recordings of two adjacent images may be chosen according to the needs.

The analysis device 4 may include, for example, a commercial personal computer such as a desktop or a notebook running a program for computation of volumetric and/or mass flow-rate of the mixture using the image sequence received from the detection device 3 and for delivering the looked-for results. Depending on the amount of processing required, the analysis device 4 may alternately include a general purpose microprocessor, a field programmable gate array (FPGA), a microcontroller, or any other hardware that includes processing circuitry and input/output circuitry suitable for computation of flow velocity based on the images received from the detection device 3.

Referring to FIGS. 3 to 5, an example of the flow velocity computation in the above-mentioned effluent flow regime includes three phases (e.g., water, oil and gas) is described below. Possible voltage and current versus time dependencies applied to the X-ray tube are shown in FIGS. 3 and 4. The duration of the pulse of photons (e.g., t2-t1) is chosen in a way that the chosen or required number of readouts (cf, ta, tb, tbc, td, te) with the detection device 3 may be done. In the present example, in total, five readouts per pulse are chosen. The determination of the duration of a pulse is dependent from the characteristics of the apparatus 1.

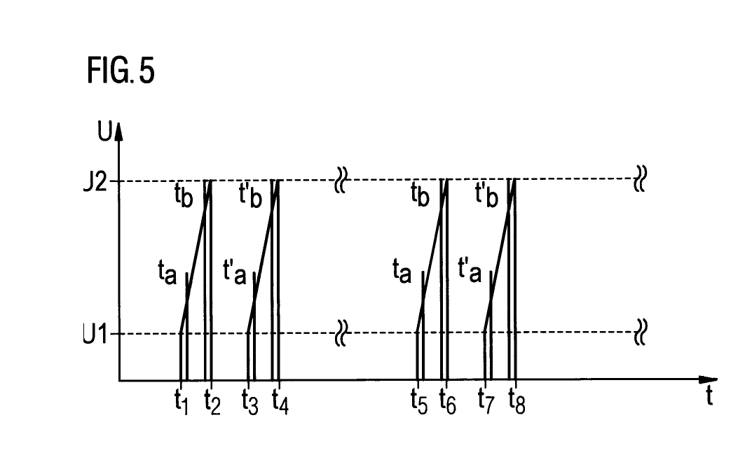

In the present example, it is assumed that the multi-phased flow passes through the flow-meter with the test section 19 of cross-section having dimensions of 40 mm×40 mm with a mixture velocity of 20 m/s. The pixel size of the detecting device 3 may be 100 μm. Accordingly, the sensor of the detecting device has a resolution of 400×800 pixels. According to FIG. 5, in total, four X-ray pulses are following in sequences in a manner that each sequence includes two or more well-defined pulses, as illustrated in FIG. 5. The pulse duration is set to be Δtp=t2-t1=t4-t3=t6-t5=t8-t7≈200 μs. During this time, the flow of the mixture will cover a distance Δx=200·10⁻⁶[s]·20 [m/s]=4 mm. This provides that the flow pattern will be shifted by around 40 pixels at the sensor of the detection device 3. If the detection device during each pulse in the sequence is acquiring X-ray images in the moment indicated in FIGS. 3 and 4, the number of actually acquired images depends on, for example, the sensor capability, the X-ray signal intensity, and the flow velocity. At least two images for each pulse are to be acquired.

Since the flow of the mixture during the pulse moves only around 40 pixels out of 800 pixels, portions of the frames with the same flow pattern may be chosen. Thus, an accurate mixture composition measurement may be provided.

Assuming that the time between two pulses in a single sequence is around 200 μs, the timing between the acquisition of images for pulses in the sequence Δtv=t′a-ta=t′b-tb≈400 μs. During this time, difference the flow of the mixture will cover a distance towards the downstream pipe of Δx=400·10⁻⁶[s]·20 [m/s]=8 mm. This distance equals to 80 pixels of the detecting device 3. Thus, by conducting a cross-correlation for image paths taken at t′a, to and t′b, tb, respectively, the velocity may be measured for each phase of the mixture separately. The current during each X-ray pulse may also be adjusted in a manner that an optimal quality of the image will be achieved by the detection device 3.

Although the invention has been described with reference to specific embodiments, this description is not meant to be construed in a limiting sense. For example, the proposed technique may be used for directly measuring volumetric flow velocities of multi-phased mixture, containing more than or less than three phases, by acquiring a corresponding number of images of different energy levels of photons within a single pulse of photons. The shape of illustrated time-dependent voltage and current may be varied. Correspondingly, the timing, the number of pixels of the detecting device, the number of acquired images, and/or the voltage of the X-ray tube may be chosen in a different manner according to, for example, available equipment, flow rate, and flow composition.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. An apparatus for measurement of a flow-rate, a composition of a multi-phase fluid mixture, or the flow-rate and the composition of the multi-phased fluid mixture, the apparatus comprising:
a radiation device operable to generate a pulsed beam of photons to irradiate the multi-phase fluid mixture spatially along a section of flow of the multi-phase fluid mixture;
a controlling device operable to apply a voltage to the radiation device;
a detection device spatially configured for receiving photons emanating from the section of flow of the multi-phase fluid mixture to form images of a spatial distribution of the received photons for each of points in time; and
an analysis device configured to determine the flow-rate of one or more phases of the multi-phase fluid mixture, the composition of the multi-phase fluid mixture based on a temporal sequence of the images of the spatial distribution of the received photons,
wherein the voltage applied to the radiation device is a predetermined, time-dependent voltage having any course between a starting voltage and an end voltage during a single pulse of photons, and
wherein the photons emanated from the section of flow of the multi-phase fluid mixture are received at different points in time during the single pulse of photons.

2. The apparatus of claim 1, wherein the radiation device is configured to apply a predetermined, time-dependent current to the radiation device to have the number of photons acquired by the detection device in a predetermined range.

3. The apparatus of claim 1, wherein the detection device is configured to form at least two images of a spatial distribution of received photons at the different points in time.

4. The apparatus of claim 1, wherein the detection device comprises a two-dimensional array of detector elements.

5. The apparatus of claim 1, wherein the analysis device is configured to determine a flow velocity of one or more phases of the multi-phased fluid mixture based on cross-correlation of a temporal sequence of images of the spatial distributions of received photons.

6. The apparatus of claim 5, wherein the detection device is configured to control a timing between acquisition of the images of different pulses such that the images are made for same energy bands.

7. The apparatus of claim 5, wherein the detection device is configured to control a timing between acquisition of the images of different pulses such that the images are made for different energy bands.

8. The apparatus of claim 1, wherein the radiation device is configured to adjust a time between succeeding pulses of photons.

9. The apparatus of claim 2, wherein the detection device is configured to form at least two images of a spatial distribution of received photons at the different points in time.

10. The apparatus of claim 2, wherein the detection device comprises a two-dimensional array of detector elements.

11. A method for measurement of a flow rate, a composition of a multi-phase fluid mixture, or the flow rate and the composition of the multi-phase fluid mixture, the method comprising:
generating a beam of photons to irradiate the multi-phase fluid mixture spatially along a section of flow of the multi-phase fluid mixture, the generating comprising applying a voltage to a radiation device during a single pulse of photons, wherein the applying comprises applying a predetermined, time-dependent voltage having any course between a starting voltage and an end voltage during a single pulse of photons;
spatially receiving photons emanating from the section of flow of the multi-phase fluid mixture, and forming images of a spatial distribution of the received photons for each of points in time;
determining a flow rate of one or more phases of the multi-phase fluid mixture, the composition, or the flow rate of the one or more phases of the multi-phase fluid mixture and the composition based on a temporal sequence of the images of the spatial distributions of the received photons; and
receiving the photons emanated from the section of flow of the multi-phase fluid mixture at different points in time during the single pulse of photons.

12. The method of claim 11, further comprising applying a predetermined, time-dependent current to the radiation device to acquire a number of photons with a detection in a predetermined range.

13. The method of claim 11, wherein forming images of the spatial distribution of the received photons for each of points in time comprises forming at least two images of the spatial distribution of the received photons at the different points in time.

14. The method of claim 11, wherein spatially receiving the photons comprises receiving the photons over a two-dimensional array of detector elements.

15. The method of claim 14, further comprising determining a spatial density distribution of one or more phases of the multi-phase fluid mixture based on the images of the spatial distribution of photons received over the two-dimensional area.

16. The method of claim 11, wherein a timing between acquisition of the images of different pulses is controlled such that the images are made for the same energy bands.

17. The method of claim 11, wherein a timing between acquisition of the images of different pulses is controlled such that the images are made for different energy bands.

18. The method of claim 12, wherein forming images of the spatial distribution of the received photons for each of points in time comprises forming at least two images of the spatial distribution of the received photons at the different points in time.

19. The method of claim 12, wherein spatially receiving the photons comprises receiving the photons over a two-dimensional array of detector elements.

20. The method of claim 19, further comprising determining a spatial density distribution of one or more phases of the multi-phase fluid mixture based on the images of the spatial distribution of photons received over the two-dimensional area.
